(19) United States
(12) Patent Application Publication
(10) Pub. No.: US 2009/0101453 A1
(43) Pub. Date: Apr. 23, 2009

(54) Electromechanical Zero Backlash Brake

(76) Inventors: Christian Baier-Welt, Ober-Ramstadt (DE); Monika Blendel, Bad Soden (DE); Lars Emmel, Wlesbaden (DE); Stefan Pfeiffer, Eppstein (DE); Hendrik Powileit, Schmitten (DE); Marcel Rigorth, Babenhausen (DE); Mathias Wurges, Konigstein (DE); Heinrich Zuber, Schwalbach am Taunus (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/094,357

(22) PCT Filed: Nov. 20, 2006
(86) PCT No.: PCT/EP2006/068675

§ 371 Date: Sep. 26, 2008

(30) Foreign Application Priority Data
Nov. 21, 2005 (DE) 10 2005 055 295.1

(51) Int. Cl. F16D 65/21

(52) U.S. Cl. 188/72.7; 188/72.2

(57) ABSTRACT

The invention relates to an electromechanical brake (10), especially for vehicles, which comprises an electrical actuator (18) producing an actuation force and acting upon at least one friction member (21) in order to force said member against a component (21) of the brake to be slowed down, thereby eliciting a frictional force. The invention also comprises a self-energizing system arranged between the friction member (21) and the electrical actuator (18). Said system comprises a wedge arrangement (11) that serves to self-boost the actuation force produced by the electrical actuator (18). The aim of the invention is to simplify said system in terms of design and control technology. For this purpose, the actuator (18) has a single electric motor (24) and the actuation force produced by it is released via a spindle/nut arrangement (30) having a rotationally received, stationary spindle (26) and a rotationally fixed nut (28) that can axially travel on the spindle by rotating the spindle. Alternatively, the nut is received so as to be stationary and rotatable and the spindle is rotationally fixed and can axially travel. The spindle (26) is rotationally received by means of axially prestressed bearings (36, 38) and the nut (28) is mounted on the spindle (26) in a manner axially prestressed in relation to the spindle. The traveling movement of the nut (28) is transmitted onto the wedge arrangement (11) by means of a transmission element which is connected to the nut (28) and to the wedge arrangement (11) with zero backlash.

The invention relates to an electromechanical brake, especially for vehicles, which comprises an electrical actuator producing an actuation force and acting upon at least one friction member in order to force said member against a component of the brake to be slowed down, thereby eliciting a frictional force and a self-energizing system arranged between the friction member and the electrical actuator and comprising a wedge arrangement that serves to self-boost the actuation force produced by the electrical actuator. The wedge arrangement has at least one wedge with a gradient angle a, which is supported against an associated support. Such an electromechanical brake is known from WO 02/095257.

Another electromechanical brake with a self-energizing system is known from the German patent specification DE 198 19 564 C2. In the case of the brake described in this document, the problem arises that the extent of self-boosting, determined by the selection of the gradient angle α of the wedge or wedges of the wedge arrangement, can always only be dimensioned so large that irrespective of the friction coefficient p between the friction lining and the component to be slowed down, which changes depending on the operating state of the brake, either a compressive force or a tractive force is always exerted on the wedge of the self-energizing system. A change of sign of the actuator force is to be avoided, because otherwise the backlash existing in the actuator has to be passed through, which results in undefined states and thus in unwanted fluctuations in the control parameters (braking force). As a result of these restrictions, with the electromechanical brake known from the said document, the range of the optimum self-boost, namely the range in which the value of the friction coefficient u corresponds at least approximately to the value tan α, cannot be used, because the required actuation force, in other words the actuator force, changes its direction at the point of optimum self-boost, i.e. if the friction coefficient μ has the same value as the tangent of the gradient angle α.

In accordance with the aforementioned WO 02/095257, the problem of the actuator backlash is solved by means of an actuator, which has two electric motors, which operate against one another in a defined manner in order to eliminate actuator backlash which exists in most operating situations. Such a solution apparently defines an increased outlay in terms of design and control technology.

The object underlying the invention is to provide an improved electromechanical brake with self-boost, the working range of which can lie within the range of the optimum self-boost without resulting in negative effects in respect of its controllability and which is still configured in a simple fashion in terms of design and can be easily handled in terms of control technology.

Based on an electromechanical brake of the type mentioned in the introduction, this object is achieved in accordance with the invention by a brake having the features specified in claim 1 or 2. To simplify the design and control technology outlay, the actuator of the inventive brake accordingly has only one single electric motor, which releases the actuation force produced thereby via a spindle/nut arrangement either having a rotationally received, stationary spindle and a rotational fixed nut that can axially travel on the spindle by rotating the spindle or a rotationally received, stationary nut and a rotationally fixed spindle that can axially travel by rotating the nut. The rotational spindle is rotationally received by means of one or several axially prestressed bearings so that no unwanted backlash occurs in the actuator. The axial prestress of receiving the spindle eliminates any axial spindle backlash. The nut is also attached prestressed to the spindle in the axial direction in relation to the spindle in order to eliminate any backlash between the nut and the spindle. Finally, the traveling movement of the nut or of the spindle is transmitted onto the wedge arrangement by means of a transmission element which is connected on the one hand to the nut or the spindle and on the other hand to the wedge arrangement with zero backlash. In this way, each actuation movement produced by the electric motor of the actuator is transmitted with zero backlash onto the wedge arrangement of the self-energizing system, irrespective of whether the momentary operating state of the brake requires the exertion of a compressive force or a tractive force onto the wedge arrangement in order to maintain a desired brake force.

In accordance with a preferred embodiment of the electromechanical brake according to the invention, at least one axially prestressed oblique ball bearing receives the rotational spindle in a prestressed fashion in the axial direction. The oblique ball bearing is arranged in a known manner to persons skilled in the art within this field such that it exerts a certain amount of pressure in the axial direction and thus eliminates potentially existing axial backlash of the spindle received therewith. Advantageously in terms of design, two axially prestressed oblique ball bearings are used to rotationally receive the spindle with zero backlash, with the axial prestress of these two bearings then taking place in opposite directions in respect of this spindle. All other bearings enabling an axial prestress such as e.g. roller or needle bearings can likewise be used. Alternatively, the rotational spindle is received in a fixed/moveable bearing arrangement.

With preferred exemplary embodiments of the inventive electromechanical brake, the axial prestressing of the nut in respect of the spindle is realized here in that the nut includes two nut elements which are axially prestressed in respect of each other. The two nut elements have an adjustable and fixable axial distance from one another. The axial distance of the two nut elements is adjusted such that backlash no longer exists in respect of the spindle and this axial distance is then fixed in order to eliminate any backlash between the nut and the spindle. For instance, the two nut elements can be connected to one another by way of an axial thread, so that the axial distance between both nut elements can be adjusted and fixed by means of a counter nut by means of screwing the one nut element into and out of the other nut element.

With a preferred embodiment of the inventive electromechanical brake, the transmission element is a coupling bar which is pivotably coupled to the nut or the spindle and the wedge arrangement, the bearing points of which are prestressed with zero backlash. According to one embodiment, the bearing points are embodied as a polygonal profile so that a zero backlash position is achieved by means of rotation which is carried out relative to one another. The bearing points can also be embodied as solid body links, e.g. in the shape of a leaf spring. Alternatively, each other transmission element can be used, which is either with zero backlash or can be configured with zero backlash by suitably embodying its linkage points and/or bearing points. For instance, a two-piece rod which is pivotably coupled to the nut or spindle and the wedge arrangement can be used as a transmission element, the two parts of which are connected to one another by means of a thread engagement. By screwing the one part into and/or out of the other respectively, the length of such a rod can be adjusted such that backlash present on the linking and/or bearing points no longer has an effect.

With preferred embodiments of the inventive electromechanical brake, the spindle extends in parallel or in any case almost parallel to a wedge bevel of the wedge arrangement. The wedge bevel is preferably that which is used for braking in the direction in which the most braking processes are expected. In the case of a brake for a motor vehicle, this wedge bevel will be the wedge bevel responsible for braking while traveling forward. The spindle arranged at least essentially parallel to the wedge bevel provides for hardly any and/or no relative movement to still occur between the nut or the spindle of the spindle/nut arrangement and the component of the wedge arrangement moved by the actuator, if this is such a brake in which the wedge bevel of the wedge arrangement which is parallel to the spindle is used. The spindle which is arranged at least essentially parallel to the wedge bevel, which corresponds to the main braking direction, is also characterized in the case of braking actions in the main braking direction by the extensive or complete absence of shear forces, which would otherwise, i.e. in the event of an arrangement of the spindle selected at least essentially parallel to the wedge bevel, act upon the spindle.

With applications of the inventive electromechanical brake, in which the gear reduction of the rotary motion of the electric motor which is achieved by the spindle/nut arrangement is not sufficient, the electric motor can itself be embodied as a engine/transmission unit in order to provide a larger overall gear reduction.

On the whole, provision is made in accordance with the invention, as a result of only one spindle/nut arrangement and only one electric motor, for a more cost-effective electromechanical brake which is easier to control in terms of control technology and is of a simpler design.

Two exemplary embodiments of an inventive electromechanical brake are described in more detail below with reference to the appended schematic figures, in which;

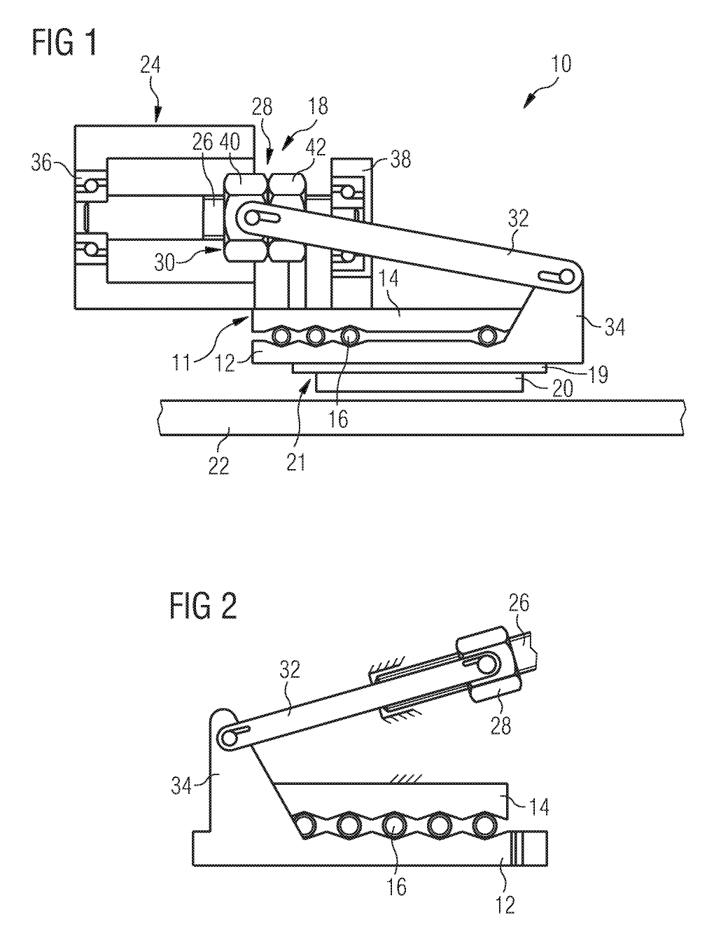

FIG. 1 shows a partially cutout view of the most important components of a first exemplary embodiment of an inventive electromechanical brake having a self-energizing system, and

FIG. 2 shows a detailed view of a second exemplary embodiment of an inventive electromechanical brake having a self-energizing system which is modified by comparison with FIG. 1.

FIG. 1 shows sections of a first exemplary embodiment of an electromechanical brake 10 which are detailed here as a disk brake for a motor vehicle and which are of particular interest within the scope of the present invention. The brake 10 includes an integrated self-energizing system, as is known for instance from the already cited WO 02/095257, to which reference is made in detail. Such a self-energizing system has a wedge arrangement 11 with two wedge plates 12, 14, between which rollers 16 are arranged for friction reduction purposes. In order to actuate the vehicle brake 10, the one wedge plate 12 is moved relative to the other wedge plate 14 by means of an actuator 18, as a result of which the distance between the two wedge plates 12, 14 increases. The stroke thus occurring as standard in one direction in respect of the main planes of the two wedge plates 12, 14 is used to bring a friction member 21 consisting of a lining support plate 19 and a friction lining 20 affixed thereto into contact with a brake disk 22. If the brake disk 22 rotates, it exerts a drive force on the friction lining 20 by way of the frictional force occurring between the friction lining 20 and the brake disk 22, said drive force effecting an additional “spreading” i.e. a larger stroke of the wedge arrangement 11 and thus a corresponding increase in the force, with which the friction lining 20 is pressed against the brake disk 22, back to the wedge plates 12, 14, without the force generated by the actuator 18 itself needing to be increased for this purpose.

The actuator 18 includes a single electric motor 24, which may set a rotationally received, axially stationary spindle 26 to rotate. A nut 28 is arranged on the spindle 26 in a rotationally fixed fashion, said nut 28 being able to travel axially on the spindle by rotating said spindle 26. As an alternative, the nut can be received in a stationary and rotational fashion and the spindle can travel axially in a rotationally fixed fashion (not shown). The spindle 26 and the nut 28 together form a spindle/nut arrangement 30.

A coupling rod 32 is used to transmit the axial movement of the nut 28 effected by rotating the spindle 26 onto the wedge plate 12, said coupling rod 32 being pivotably coupled with its one end to the outside of the nut 28 and with its other end to an appendage 34 of the wedge plate 12.

The electric motor 24 of the actuator 18 is activated in order to actuate the brake 10 so as to set the spindle 26 to rotate in the one or the other direction. The desired rotational direction of the spindle 26 depends on the direction in which the brake disk 22 to be slowed down rotates. So that the self-energizing system is able to fulfill its function, the actuator 18 must move the wedge plate 12 in respect of the wedge plate 14 in the direction in which the brake disk 22 also rotates. It is only then that the rollers 16 between the two wedge plates 12 and 14 run to those wedge bevels, which, following contact of the friction lining 20 with the brake disk 22, effect a further spreading of the wedge arrangement 11 and thus the desired self-boost. The spindle 26 is rotated in the opposite direction in order to terminate the braking action, as a result of which the two wedge plates 12, 14 approach one another again and the friction lining 20 disengages from the brake disk 20.

For the reasons illustrated in the introduction (possible change between a traction wedge arrangement and a compressive wedge arrangement as a function of the frictional value prevailing between the friction lining and the brake), any backlash in the actuator 18 is unwanted. To avoid such backlash, the brake 10, in more precise terms the actuator 18 thereof, has a series of measures. The spindle 26 is thus rotationally received by means of two axially prestressed ball bearings 36, 38. In the exemplary embodiment shown, the two ball bearings 36, 38 are oblique ball bearings, which axially prestress the spindle 26, i.e. apply a force acting in the axial direction upon the spindle 26. The axial prestresses applied by the ball bearing 36 and/or 38 on the spindle 26 are aligned oppositely, so that any axial backlash in the spindle 26 is eliminated.

To eliminate backlash between the nut 28 and the spindle 26, the nut is attached to the spindle using axial prestress. In the exemplary embodiment shown, the nut 28 consists of two nut elements 40, 42, which are connected to one another by way of a screw thread (not shown) and can be moved axially towards and away from one another by means of screwing in the one and/or the other direction. The axial distance between the two nut elements 40, 42 can thus be adjusted. In order to eliminate backlash, the axial distance of the two nut elements 40, 42 is thus changed until there is no backlash still present in the spindle 26. The established position of the nut elements 40, 42 is fixed by means of a counter nut (not shown).

The coupling rod 32 can have backlash on its linking points. To eliminate such backlash, the linking and/or bearing points of the coupling rod 32 are prestressed in one direction, the available backlash can no longer have an effect.

The said measures ensure that each actuation movement of the actuator 18 is transmitted with zero backlash onto the wedge plate 12 of the self-energizing system. The control of the brake 10 thus proves to be considerably easier.

FIG. 2 shows a second exemplary embodiment of a brake 10, which only differs from the first exemplary embodiment illustrated in FIG. 1 in that the spindle 26 extends in parallel to that wedge bevel of the wedge arrangement 11, which is used to self-boost braking actions in the main braking direction. With one actuation of the brake 10 for braking in the main braking direction, no relative movement occurs between the moved wedge plate 12 and the nut 28 in the case of a spindle 26 which is arranged in parallel to the said wedge bevel. No shear forces are then also transmitted onto the spindle 26.

1. An electromechanical brake (10), especially for motor vehicles, comprising an electrical actuator (18), which generates an actuation force and acts on at least one friction member (21), in order to force said member against a component (22) of the brake to be slowed down in order to elicit a frictional force, and having a self-energizing system arranged between the friction member (21) and the electrical actuator (18) having a wedge arrangement (11) that serves to self-boost the actuation force produced by the electrical actuator, characterized in that
the actuator (18) only has one single electric motor (24) and the actuation produced thereby releases via a spindle/nut arrangement (30) having a rotationally received, stationary nut and a rotationally fixed spindle that can axially travel by rotating the spindle,
the nut is attached prestressed to the spindle in the axial direction in relation to the spindle, and
the traveling movement of the spindle is transmitted onto the wedge arrangement (11) by means of a transmission element, which is on the one hand connected to the spindle and on the other hand to the wedge arrangement (11) with zero backlash.

2. The electromechanical brake (10), especially for motor vehicles, comprising an electrical actuator (18), which generates an actuation force and acts on at least one friction member (21), in order to force said member against a component (22) of the brake to be slowed down in order to elicit a frictional force, and having a self-energizing system arranged between the friction member (21) and the electrical actuator (18) having a wedge arrangement (11) that serves to self-boost the actuation force produced by the electrical actuator, characterized in that,
the actuator (18) only has one single electric motor (24) and the actuation produced thereby releases via a spindle/nut arrangement (30) having a rotationally received, stationary nut (26) and a rotationally fixed nut (28) that can axially travel on the spindle by rotating the spindle
the spindle (26) is rotationally received by means of axially prestressed bearings (36, 38),
the nut (28) is attached prestressed to the spindle (26) in the axial direction in relation to the spindle, and
the traveling movement of the nut (28) is transmitted onto the wedge arrangement (11) by means of a transmission element which is connected on the one hand to the nut (28) and on the other hand to the wedge arrangement (11) with zero backlash.

3. The electromechanical brake as claimed in claim 2, characterized in that the axially prestressed bearings (36, 38) used for rotationally receiving the spindle (26) are oblique ball bearings.

4. The electromechanical brake as claimed in claim 2, characterized in that the spindle (26) is received in a fixed/moveable bearing arrangement.

5. The electromechanical brake as claimed in one of claims 1 to 4, characterized in that the nut (28) has two nut elements (40, 42) which are axially prestressed against one another.

6. The electromechanical brake as claimed in one of the preceding claims, characterized in that the transmission element is a coupling rod (32) which is pivotably coupled to the spindle or the nut (28) and the wedge arrangement (11), the bearing points of which are prestressed with zero backlash.

7. The electromechanical brake as claimed in claim 6, characterized in that the bearing points of the coupling rod (32) are embodied as a polygonal profile.

8. The electromechanical brake as claimed in claim 6, characterized in that the bearing points of the coupling rod (32) are embodied as solid body links.

9. The electromechanical brake as claimed in one of the preceding claims, characterized in that the spindle (26) extends at least essentially parallel to a wedge bevel of the wedge arrangement (11).

10. The electromechanical brake as claimed in claim 9, characterized in that the wedge bevel is the wedge bevel which is responsible for a braking action when traveling forward.

11. The electromechanical brake as claimed in one of the preceding claims, characterized in that the electric motor (24) is embodied as an engine/transmission unit.
